(19) United States
(12) Patent Application Publication
(10) Pub. No.: US 2007/0230435 A1
(43) Pub. Date: Oct. 4, 2007

(54) Packet relaying apparatus

(75) Inventor: Kenji Anzai, Atsugi-shi (JP)

Correspondence Address: Patrick G. Burns;GREER, BURNS & CRAIN, LTD., Suite 2500, 300 South Wacker Drive, Chicago, IL, 60606, US

(73) Assignee: ANRITSU CORPORATION

(21) Appl. No.: 11/726,855

(22) Filed: Mar. 23, 2007

(30) Foreign Application Priority Data
Mar. 31, 2006 (JP) 2006-099112

(51) Int. Cl. H04L 12/28

(52) U.S. Cl. 370/351; 370/389

(57) ABSTRACT

A packet relaying apparatus which relays packets with a guaranteed bandwidth between terminals is comprised of a session control information analyzing section which identifies a required bandwidth required for a session to be established between the terminals by analyzing session control information contained in packets of control session protocols between the terminals, and a bandwidth correction section which corrects the identified required bandwidth based on the header size information of the packets, in order to guarantee the corrected bandwidth for the packets relating to the session.

### BACKGROUND OF THE INVENTION

1. Field of the Invention

The present invention relates to packet relaying apparatuses for relaying packets through networks.

2. Description of the Related Art

Some packet relaying apparatuses are already known as being suitable for maintaining the Quality of Service (QOS) on providing the service of real-time communication such as voice and video over the Internet. For example, when a session is established to exchange Real-time Transport Protocol (RTP) packets, one of those existing packet relaying apparatuses maintains the QOS by guaranteeing the required bandwidth for the established session.

Japanese Unexamined Patent Application Publication No. 2003-158543 (U.S. Patent Application No. 20030097460) discloses such the packet relaying apparatus. When the packet relaying apparatus receives a Real Time Streaming Protocol (RTSP) packet based on a control session protocol, the apparatus detects the required bandwidth for the session by analyzing the received packet, and the reservation admission control section of the packet relaying apparatus decides whether it is possible to guarantee the detected bandwidth for the session.

Moreover, when a session is required to be established, the packet relaying apparatus disclosed in the above publication can allocate both of minimum and maximum rates for the queues of the packet scheduler. The minimum rate is the required bandwidth for the session, and the maximum rate is the required bandwidth for the session plus a margin for overheads and the like relating to the RTP packets. The overheads are, for example, User Datagram Protocol (UDP) header, Internet Protocol (IP) header, and other headers of lawyer layer protocols, which are added to the RTP packets to be transmitted over the Internet.

Unfortunately, when the difference between the minimum rate and the maximum rate is set too small on the packet relaying apparatus described above, some RTP packets may be dropped if the overheads of those packets are larger than the difference. On the other hand, when the difference between the minimum rate and the maximum rate is set too large, the throughput efficiency is degraded.

The present invention is made to solve the problem of the conventional art, aiming to provide a packet relaying apparatus which improves the throughput efficiency while preventing the packets from being dropped.

### SUMMARY OF THE INVENTION

In accordance with an aspect of the present invention, a packet relaying apparatus includes a session control information analyzing section operative to identify a required bandwidth for a session by analyzing session control information transmitted from a terminal for establishing the session, a bandwidth correction section operative to derive a header information size and to correct the required bandwidth based on the header information size, and a packet relaying section operative to relay packets transmitted from the terminal with guaranteeing the required bandwidth corrected by the bandwidth correction section.

Preferably, the bandwidth correction section of the packet relaying apparatus according to the present invention may derive the header information size by taking header information appended to a packet transmitted from the terminal for establishing the session.

Alternatively, the bandwidth correction section may include a table of header information sizes by ports of the packet relaying apparatus and derive the header information size by referencing the table.

Preferably, the session control information analyzing section of the packet relaying apparatus according to the present invention may identify the required bandwidth for the session based on required bandwidth information contained in the session control information.

If the session control information does not contain the required bandwidth information, the session control information analyzing section may identify the required bandwidth for the session based on encoding specification information contained in the session control information.

Preferably, the session control information analyzing section of the packet relaying apparatus according to the present invention may identify a bit rate and a packet rate required for the session, and the bandwidth correction section may correct the required bandwidth by adding a product of the header information size and the packet rate to the bit rate.

The object of the present invention is to provide a packet relaying apparatus which improves the throughput efficiency of relaying packets while preventing the packets from being dropped.

### BRIEF DESCRIPTION OF THE DRAWINGS

FIG. 1 is a configuration diagram of a communication system in accordance with the embodiment of the present invention.

FIG. 2 is a sequence diagram according to the Session Initiation Protocol (SIP) on starting IP telephone between terminals.

FIG. 3 is a block diagram of the packet relaying apparatus in accordance with the embodiment of the present invention.

FIG. 4 is an example of the flow table in accordance with the embodiment of the present invention.

FIG. 5(A) is an example of a packet in accordance with the embodiment of the present invention.

FIG. 5(B) is another example of a packet in accordance with the embodiment of the present invention.

FIG. 6 shows relationships of queue IDs and corrected bandwidths in a table format.

FIG. 7 is a flowchart showing the procedures of the packet relaying apparatus in accordance with the embodiment of the present invention.

FIG. 8 shows a couple of options for the combination of required bandwidth information.

### DESCRIPTION OF THE PREFERRED EMBODIMENT

A preferred embodiment according to the present invention will be described with reference to the drawings.

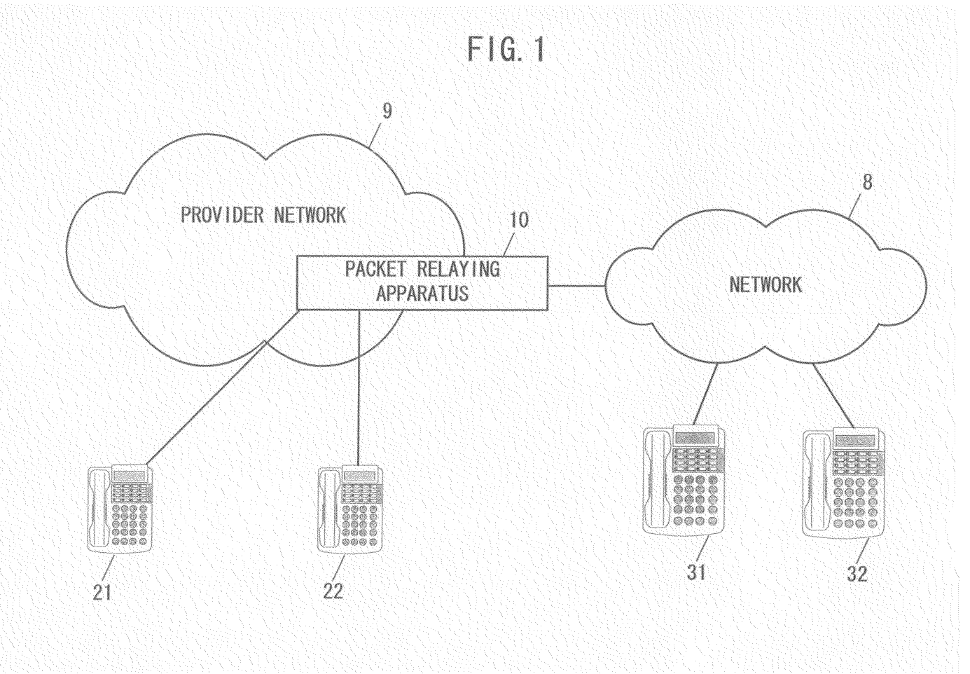

FIG. 1 is a configuration diagram of a communication system in accordance with the embodiment of the present invention. As shown in FIG. 1, terminals 21 and 22 are connected to a provider network 9 provided by an Internet service provider (ISP), and terminals 31 and 32 are connected to a network 8. The provider network 9 and the network 8 are connected each other through a packet relaying apparatus 10.

Terminals 21, 22, 31 and 32 are IP telephone terminals that transmit and receive packets conforming to IP (IP packets hereinafter) in the present embodiment. Those terminals are not limited to the IP telephone terminals but can be other terminals such as video phones that transmit and receive packets for real time communication, or can be servers and terminals that transmit and receive packets of voice or video data by any of streaming media technologies.

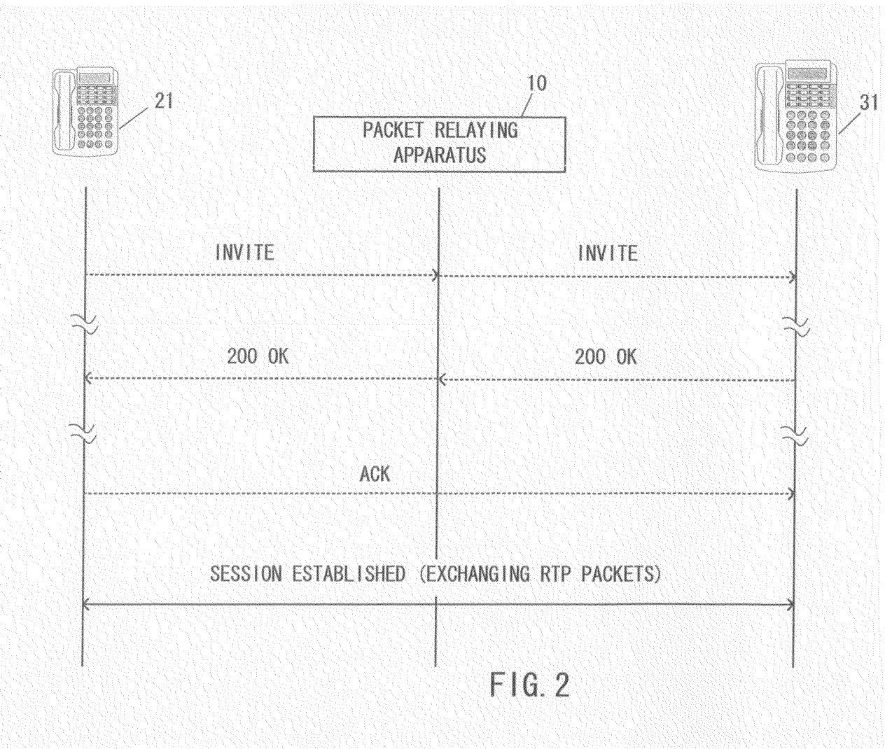

FIG. 2 is a sequence diagram according to the Session Initiation Protocol (SIP) on starting IP telephone between the terminals 21 and 31. As shown in FIG. 2, SIP messages such as INVITE are exchanged before the session is established for the IP telephone. Through the sequence according to the SIP, the packet relaying apparatus 10 detects the required bandwidth for the session and then relays the packets with keeping the bandwidth.

After the session is established, RTP packets are exchanged between the terminals 21 and 31 to transfer voice data in real time. For example, an RTP packet transmitted from the terminal 21 is relayed by the packet relaying apparatus 10 to the terminal 31 through the network 8.

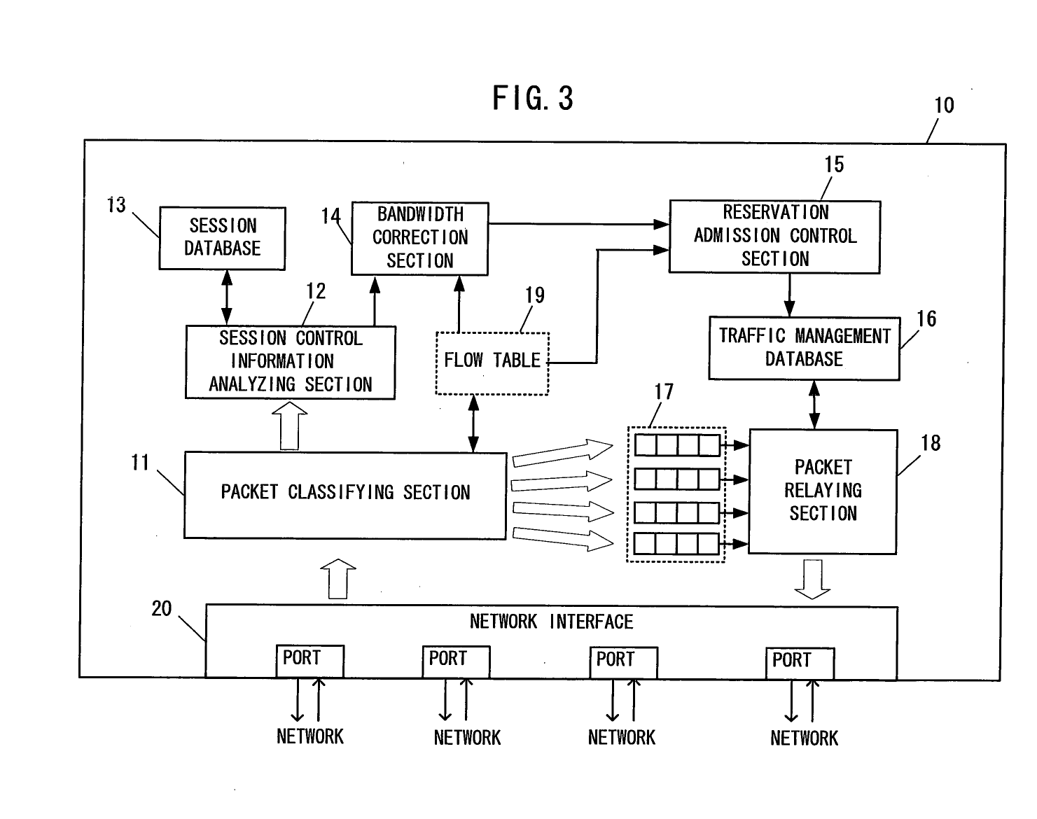

When the packet relaying apparatus 10 receives an RTP packet transmitted from the terminal 21, it secures the bandwidth for the RTP packet and the header information relating to the RTP packet, and then relays the packet to the network 8. The packet relaying apparatus according to the present invention will be described. FIG. 3 is a block diagram of the packet relaying apparatus in accordance with the embodiment of the present invention.

The packet relaying apparatus 10 includes a processor such as a CPU, a memory such as RAM and ROM, a network interface 20 for processing packets received from a network or to be sent to the network, although the processor and the memory are not shown in the FIG. 3. The network interface 20 receives and transmits packets through ports that work as gateways to the network.

Moreover, as shown in FIG. 3, the packet relaying apparatus 10 further comprises a packet classifying section 11, a session control information analyzing section 12, a session database 13, a bandwidth correction section 14, a reservation admission control section 15, a traffic management database 16, buffer queues 17, and a packet relaying section 18.

The packet classifying section 11, the session control information analyzing section 12, the session database 13, the bandwidth correction section 14, the reservation admission control section 15, the traffic management database 16 and the packet relaying section 18 can be program modules executed by a processor, or can be an integrated circuit.

The packet classifying section 11 classifies a received packet by referencing a flow table 19, and outputs the packet to one of plural buffer queues 17 depending on the result of the classification.

When the packet classifying section 11 references the flow table 19 but does not find an entry of a flow to which the packet is to belong, the packet classifying section 11 adds the entry to the flow table 19 with the destination IP address, the source IP address, the protocol, the destination port number, and the source port number.

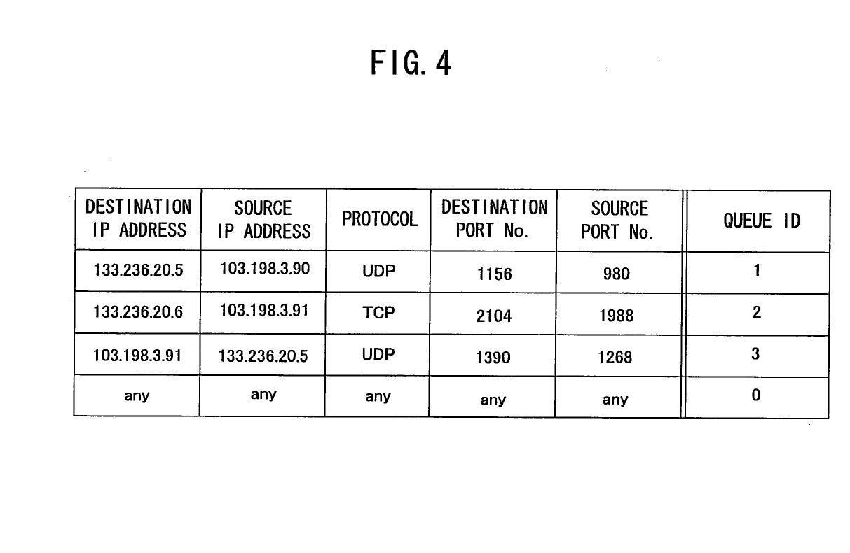

FIG. 4 is an example of the flow table 19. As shown in FIG. 4, a queue ID is identified by a set of a destination IP address, a source IP address, a protocol, a destination port number, and a source port number. The queue ID is identification information for identifying each buffer queue, used within the packet relaying apparatus according to the present invention.

Moreover, when the packet classifying section 11 receives a packet which contains session control information such as a SIP message to establish a session, the packet classifying section 11 duplicates the packet, then outputs one to the session control information analyzing section 12 and outputs the other to a buffer queue 17 at the same time.

The session control information analyzing section 12 identifies a required bandwidth by analyzing session control information contained in, for example, an INVITE message and a response message to the INVITE message. The session control information analyzing section 12 also stores session data including the required bandwidth for the session into the session database 13.

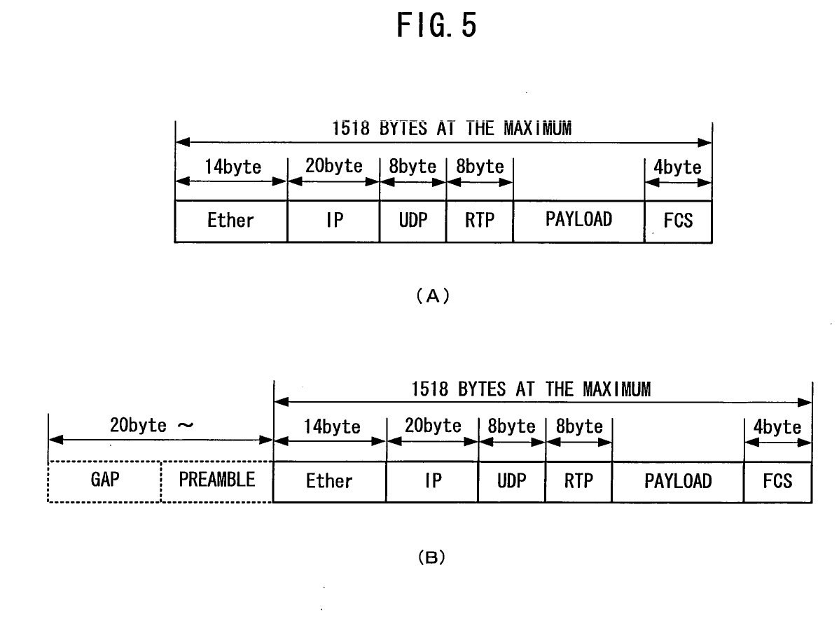

The bandwidth correction section 14 corrects the required bandwidth identified by the session control information analyzing section 12, based on a header information size of the packet. For example, when the packet relaying apparatus 10 is about to transmit information (a payload) of real time communication contained in a packet according to Ethernet®, IP, UDP and RTP, it should append header information and footer information to the payload, as shown in FIG. 5(A). The bandwidth correction section 14 derives the header information size to be appended to the packet by using the information in the flow table 19, and corrects the required bandwidth %with the header information size, which is 54 bytes in total of Ethernet®, IP, UDP, and RTP header information in this example.

In another example of a transmission system where, as shown in FIG. 5(B), a gap and/or a preamble is inserted between packets, the bandwidth correction section 14 may include the gap and the preamble into the correction of the required bandwidth.

In other words, the header information in this description is not limited to the information appended to a packet as a header but can include the information appended as a footer and others such as the gap and the preamble which, although not directly recognized by users, are required by communication standards and consume some bandwidth in practice.

The reservation admission control section 15 determines whether the session is acceptable to use the bandwidth corrected by the bandwidth correction section 14. If the session is acceptable, the reservation admission control section 15 generates a queue in the buffer queues 17 to queue packets for the corrected bandwidth, and stores the value of the corrected bandwidth into the traffic management database 16.

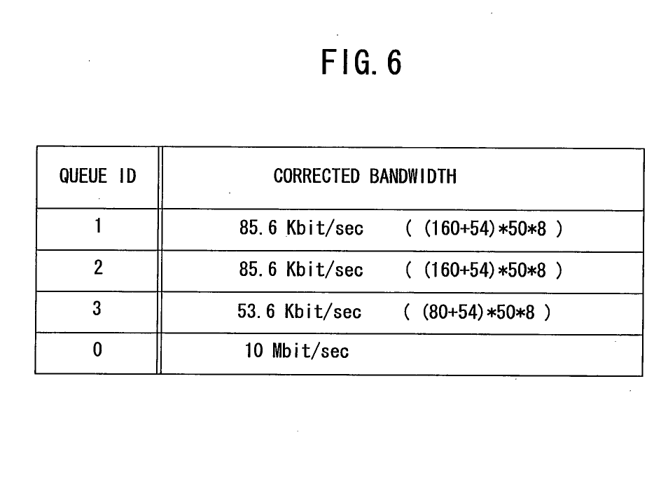

The traffic management database 16 stores values of corrected bandwidths by queue IDs of the flow table 19. In an example shown in FIG. 6, each value of a corrected bandwidth is stored with the corresponding queue ID in a table format. For example, the bandwidth for the queue ID 1 is the bandwidth corrected by the bandwidth correction section 14, by using values: the packet rate of 50 packets/sec for a session, the packet size of 160 bytes per packet (which make the nominal bit rate of 64K bits/sec for the session), and the header information size of 54 bytes for Ethernet®, IP, UDP and RTP.

In this embodiment, the session control information analyzing section 12 derives the required bandwidth for the session to be established from the bit rate and the packet rate based on the SIP message. Then the bandwidth correction section 14 derives the corrected bandwidth by using the following equation:

corrected bandwidth=((Rd/(Rp*8))+Ph)*Rp*8, (Equation 1)

where, Rd is the bit rate (bits/sec), Rp is the packet rate (packets/sec), and Ph is the header information size (bytes).

The packet relaying section 18 outputs packets queued in the buffer queues 17 to the network interface 20 according to the corrected bandwidth stored in the traffic management database 16. For example, the packet relaying section 18 outputs 50 packets (214 bytes per packet) queued in the queue ID 1 in every second.

In FIG. 6, the queue ID 0 is the queue used for best effort service. If there are no queued packets in queues whose queue IDs are equal or more than 1, the packet relaying section 18 outputs a packet queued in the queue ID 0. In other case where the sum of the corrected bandwidths for the queues whose queue IDs are equal or more than 1 is less than a predetermined total bandwidth but the current sum of the corrected bandwidths plus an additional corrected bandwidth for a new session to be established exceeds the total bandwidth, the reservation admission control section 15 determines the new session to be established is not acceptable.

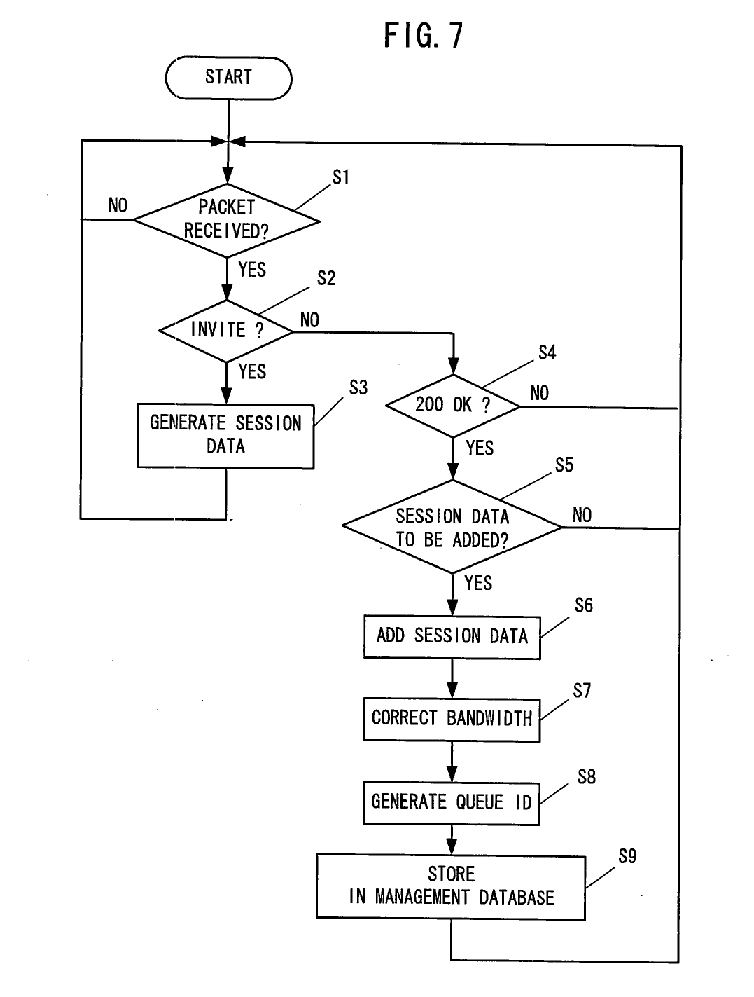

Procedures of the packet relaying apparatus 10 according to the present invention will be described below with referencing drawings. FIG. 7 is a flowchart showing the procedures of the packet relaying apparatus 10.

First, when the packet classifying section 11 receives a packet (S1), it examines whether the received packet contains an INVITE message of a SIP message (S2). If the packet contains the INVITE message, the session control information analyzing section 12 generates session data comprising the source IP address, the protocol, the source port number and the required bandwidth that are derived by analyzing the INVITE message, and stores the session data into the session database 13 (S3).

At the same time, if the packet classifying section 11 references the flow table 19 but does not find an entry of a flow to which the packet is to belong, the packet classifying section 11 adds the entry to the flow table 19 with the destination IP address, the source IP address, the protocol, the destination port number, and the source port number.

If the packet does not contain the INVITE message, the packet classifying section 11 examines whether the received packet contains a response message (200 OK) to an INVITE message (S4). If the packet does not contain the response message, the packet classifying section 11 classifies the packet by referencing the flow table 19 and outputs the packet to one of buffer queues 17 depending on the result of the classification.

If the received packet contains the response message, the session control information analyzing section 12 confirms whether the session database 13 has stored the session data relating to the response message (S5). If the session database 13 has stored the session data, the session control information analyzing section 12 adds the destination IP address, the destination port number and the information of the required bandwidth, into the stored session data (S6).

Then the session control information analyzing section 12 derives the bit rate and the packet rate, and the bandwidth correction section 14 derives the corrected bandwidth based on the Equation 1 (S7).

The bandwidth correction section 14 may determine the header information size by taking the header information appended to the SIP message. However, the header information size can vary depending on a port to which the received packet is to be output. For example, when a certain port is complying to the VLAN specification or the 100BASE-T specification, the header information size depends on such the specification. In such the case, the bandwidth correction section 14 may have a table of header information sizes by ports of the packet relaying apparatus and derive the header information size by referencing the table.

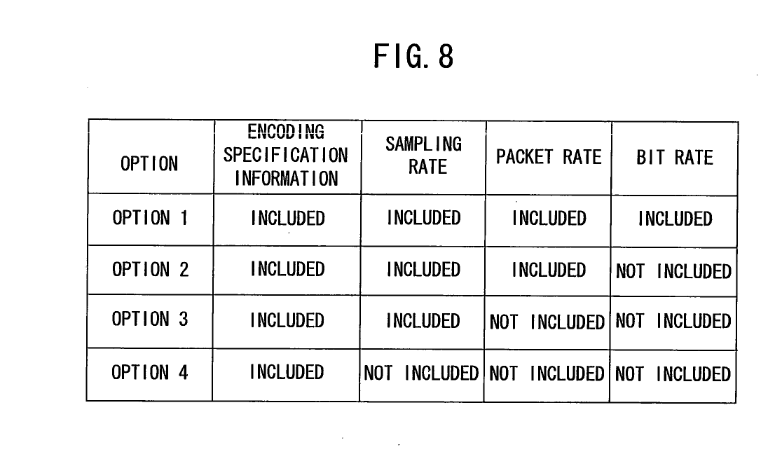

A SIP message does not always contain the bit rate or the packet rate information. As shown in FIG. 8, there are a couple of options for the combination of the required bandwidth information. The combination of the required bandwidth information can be identified by Session Description Protocol (SDP) syntax in the received SIP message.

The required bandwidth information includes encoding specification information specifying the type of encoding of real time communication, the sampling rate of the real time communication, the packet rate (packets/sec), and the bit rate (bits/sec). Some examples of the encoding specifications are G.711 series and H.261 to H.263 of ITU-T Recommendations. When a SIP message is received, the session control information analyzing section 12 examines whether such the information is contained in the SIP message.

In the case of the option 1 shown in FIG. 8, the session control information analyzing section 12 can extract all the information of the encoding specification information, the sampling rate, the packet rate and the bit rate from the SIP message. The bandwidth correction section 14 then derives the corrected bandwidth based on the Equation 1 with the extracted packet rate and the bit rate.

In the case of the option 2 shown in FIG. 8, the session control information analyzing section 12 can extract only the information of the encoding specification information, the sampling rate, and the packet rate from the SIP message. The bit rate is not contained in the SIP message. For such the case, a bit rates table is beforehand prepared containing some encoding specification information and corresponding sampling rates and bit rates. The session control information analyzing section 12 obtains the bit rate by using the bit rates table. The bandwidth correction section 14 then derives the corrected bandwidth based on the Equation 1 with the extracted packet rate and the obtained bit rate.

In the case of the option 3 shown in FIG. 8, the packet rate and the bit rate are not contained in the SIP message. The session control information analyzing section 12 obtains the bit rate based on the encoding specification information and the sampling rate and by using the above mentioned bit rates table, and sets the packet rate as the maximum value such as 50 packets/sec.

In the case of the option 4 shown in FIG. 8, only the encoding specification information is contained in the SIP message. Then the session control information analyzing section 12 sets the bit rate as the maximum specified value in the encoding specification, and sets the packet rate as the maximum value such as 50 packets/sec.

The reservation admission control section 15 generates a queue for queuing packets based on the corrected bandwidth, and stores the corrected bandwidth into the traffic management database 16 (S9).

In this embodiment of the present invention, one queue corresponds to one established session because the admission control section 15 generates a queue whenever a session is to be established. However, the present invention is not limited to such the relationship of one queue for one session.

As explained so far, the packet relaying apparatus relating to the embodiment of the present invention can improve the throughput efficiency while preventing the packets from being dropped, because the packet relaying apparatus corrects the required bandwidth required for a session based on the header size information of the packets which are transmitted from a terminal and relayed by the packet relaying apparatus, and guarantees the corrected bandwidth for the packets relating to the session.

Since the packet relaying apparatus relating to the present invention has advantages of preventing the packets from being dropped and improving the throughput efficiency of packet relaying, it is useful as a router, shaper, switch, or other network equipment which controls the bandwidth on relaying packets over the network.

What is claimed is:

1. A packet relaying apparatus comprising:
a session control information analyzing section operative to identify a required bandwidth for a session by analyzing session control information transmitted from a terminal for establishing said session;
a bandwidth correction section operative to derive a header information size and to correct said required bandwidth based on said header information size; and
a packet relaying section operative to relay packets transmitted from said terminal with guaranteeing said required bandwidth corrected by said bandwidth correction section.

2. The packet relaying apparatus according to claim 1,
wherein said bandwidth correction section derives said header information size by taking header information appended to a packet transmitted from said terminal for establishing said session.

3. The packet relaying apparatus according to claim 1,
wherein said bandwidth correction section includes a table of header information sizes by ports of said packet relaying apparatus, and derives said header information size by referencing said table.

4. The packet relaying apparatus according to claim 1,
wherein said session control information analyzing section identifies said required bandwidth for said session based on required bandwidth information contained in said session control information.

5. The packet relaying apparatus according to claim 4,
wherein said session control information analyzing section identifies said required bandwidth for said session based on encoding specification information contained in said session control information if said session control information does not contain said required bandwidth information.

6. The packet relaying apparatus according to one of claims 4 and 5,
wherein said session control information analyzing section identifies a bit rate and a packet rate, and
said bandwidth correction section corrects said required bandwidth by adding a product of said header information size and said packet rate to said bit rate.
